(19) United States
(12) Patent Application Publication
(10) Pub. No.: US 2015/0075355 A1
(43) Pub. Date: Mar. 19, 2015

(54) SOUND SYNTHESIZER

(71) Applicant: City University of Hong Kong, Kowloon (HK)

(72) Inventors: Yi Tang, Jackie CHUI, New Territories (HK); Mubarak M. MARAFA, New Territories (HK); Kar Fai, Samson YOUNG, Kowloon Tong (HK)

(73) Assignee: City University of Hong Kong, Kowloon (HK)

(21) Appl. No.: 14/028,555

(22) Filed: Sep. 17, 2013

(51) Int. Cl. G10H 1/02

(52) U.S. Cl. CPC G10H 1/02
USPC 84/609; 84/622

(57) ABSTRACT

A sound synthesizer 101 that plays a pre-determined sequence of sound notes one by one when the user taps on a touch sensitive surface 104 of the sound synthesizer 101. Different music is produced by varying the intervals between the sound notes, even from the same sequence of sound notes. The sound notes are selected according to a pre-determined scale, such as the pentatonic scale, for ease of matching to other music scales, and to reduce the disonnance between sound notes in scales such as that seen in the major scale.

### FIELD OF INVENTION

This invention relates to sound synthesizers, in particular to sound synthesizers suitable for playing music.

### BACKGROUND OF INVENTION

A long time is generally required before music beginners could enjoy the pleasure of playing interesting and self-expressive music on a musical instrument. Such beginners are often discouraged by the learning difficulties of having to master fingering techniques and score reading. The difficulty is compounded when the beginners are learning to play typical western music where the “right sound notes” have to be selected according to major and minor keys and scales, or the resultant music will sound dissonant.

Thus, beginner musicians are unlikely to be able to improvise on music until they have completed lengthy training in improvisation and music theory. Impatient beginners will find themselves compelled to give up on learning music.

Various ways to simplify music learning has been proposed. For example, electronic keyboards having light emitting diodes that light up keys in sequence according to a music score has been proposed, which guides the selection of keys and the fingering technique of the beginner. However, this only helps the beginner to identify which key is to be played next. The beginner will still have to familiarise himself with the score and become adept at keyboard fingering technique in order to play any piece of music.

Therefore, it is desirable to provide a musical device and any accompanying method which could propel the beginner into enjoying the pleasure of generating self-expressive music by reducing need or duration of instrument training.

### SUMMARY OF INVENTION

In a first aspect, the present invention proposes a sound synthesizer comprising a surface; an audio output capable of providing a different sound note each time the surface is touched.

A user of the sound synthesizer needs only now concentrate on the speed or tempo of the produced sound, and perhaps the intensity or velocity of each sound note, to create music. The user has no need to be concerned with the actual selection of the specific sound note when using the sound synthesizer. It is sufficient to produce music even by just using a single finger to tap on the surface.

Optionally, the sound note output at the audio output is randomly selected from a pre-determined musical scale each time the surface is touched. Selecting sound notes from a known scale produces music of familiar moods to the listener.

Typically, one consecutive sound note is played each time the surface is touched consecutively, and it is also possible that consecutive sound notes were pre-determined instead of randomly selected, such as in a known musical score. Preferably, the sound synthesizer further comprises a display capable of indicating the position of the sound note being produced as part of the pre-determined sequence of sound notes.

Preferably, the sound note at the output is based on the pentatonic scale. The pentatonic scale has little dissonance even if the sound notes are randomly selected and would be complementary to several genres of music including jazz, blues, rock or ethnic music.

Preferably, the surface is capable of sensing the intensity of the user's touch. The amplitude or velocity of the sound note at the audio output is proportional to the intensity of his touch.

Preferably, a touch resting on the surface produces a sound note which has aftertouch effects. Preferably, the surface is resiliently movable, the extent to which the surface is moved determining the velocity or aftertouch effects of the sound note being produced.

### BRIEF DESCRIPTION OF FIGURES

Embodiments are herein described with reference to the accompanying drawings, wherein like integers refers to like parts, wherein

FIG. 1 shows an embodiment of the invention.

FIG. 2 schematic diagram of the embodiment.

FIG. 3 shows a variation of the embodiment of FIG. 1.

FIG. 4 illustrates a prior art feature for contrasting with a corresponding feature in the embodiment of FIG. 1.

FIG. 5 illustrates a feature of the embodiment of FIG. 1.

FIG. 6 is yet a further embodiment to that of FIG. 1.

FIG. 7 illustrates a feature in the embodiment of FIG. 1.

FIG. 8 illustrates a software interface for a variation of the embodiment of FIG. 1.

FIG. 9 illustrates another aspect of the software of FIG. 8.

FIG. 10 is an illustration of a feature of the software of FIG. 8.

### DETAILED DESCRIPTION OF THE PREFERRED EMBODIMENTS

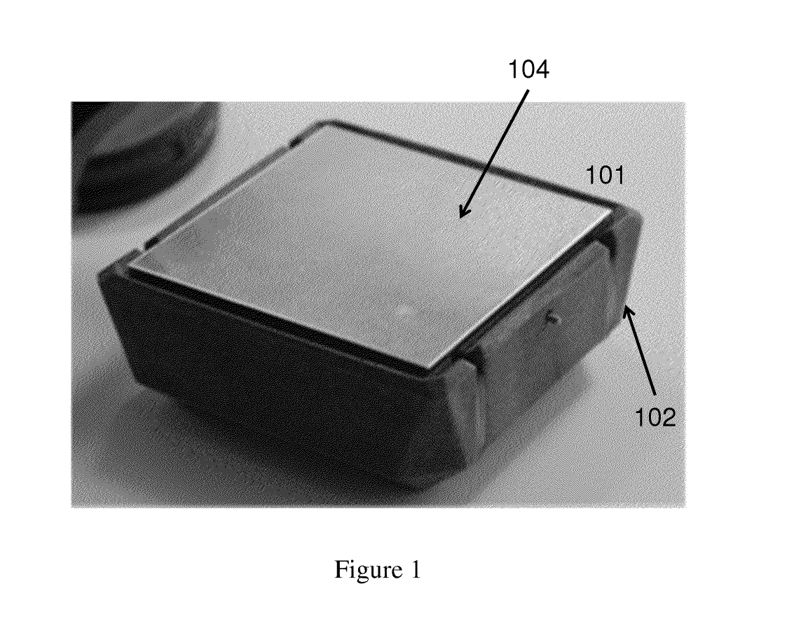

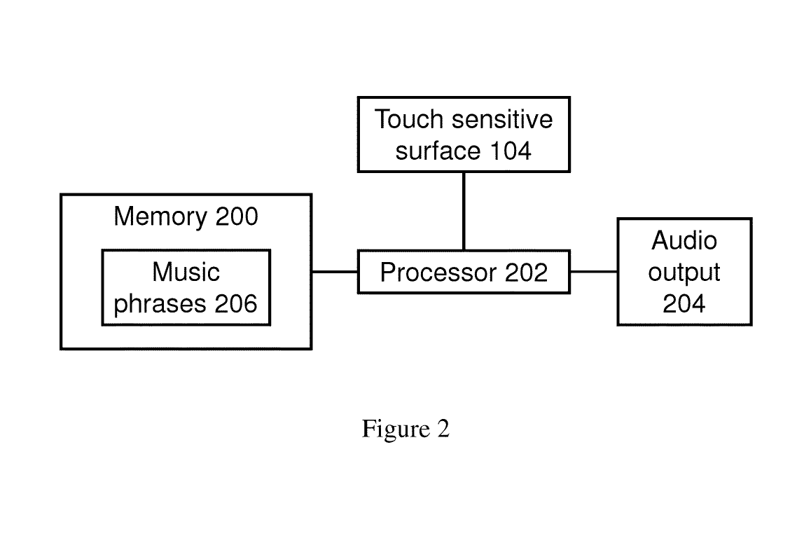

FIG. 1 shows a sound synthesizer 101 having a schematic arrangement of parts as illustrated in FIG. 2. The sound synthesizer 101 has a housing 102 which is covered by a touch sensitive surface 104. The touch sensitive surface 104 is preferably a 6 cm by 6 cm metal plate which acts as a capacitive sensor. Touching the metal plate affects a capacitance imposed on the metal plate. Therefore, a change in capacitance implies that the metal plate has been touched.

The housing 102 contains memory 200 and a processor 202. The memory 200 stores software which drives the processor 202 to detect and to respond to touch detected by the touch sensitive surface 104. Furthermore, a library 206 of music phrases is also stored in the memory 200.

The sound synthesizer 101 also has audio output 204. The audio output 204 is preferably a speaker integral to the sound synthesizer 101 or, optionally, is a signal output which can provide an audio signal that can be transmitted to a remote speaker.

When a user touches the touch sensitive surface 104 with his finger, the processor is triggered to produce a sound note at the audio output 204. One sound note is typically of a single tone. Tapping on the touch sensitive surface 104 continually triggers a respective production of several sound notes consecutively.

A musical arrangement of a plurality of sound notes is known as a phrase, which are sound notes arranged in a pre-determined order and may be of different tones. At least one phrase is pre-stored in the memory 206 for audio output. Each time the touch sensitive surface 104 is tapped on, one sound note in the phrase is produced. Consecutive tapping on the touch sensitive surface 104 output the sound notes in the phrase according to their pre-determined order until the entire phrase has been produced.

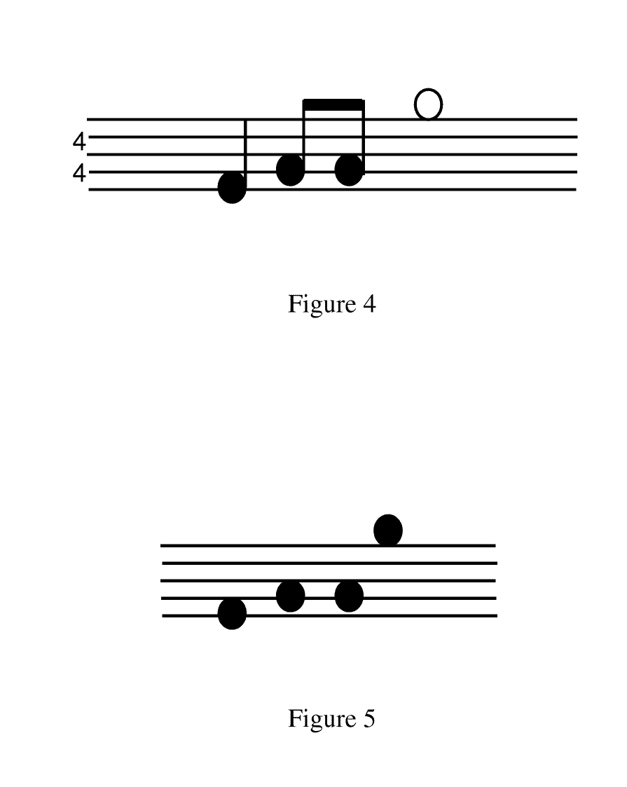

FIG. 4 shows how, in a typical music score, the order of different sound notes are pre-determined as well as the time intervals between the sound notes. In contrast, as illustrated in FIG. 5, the phrases stored in the memory of the sound synthesizer 101 are ordered as in typical music except that the intervals between the sound notes have not been determined yet. It is the user of the sound synthesizer 101 who gets to determine and vary the intervals between the sound notes, just by tapping his finger on the touch sensitive surface 104. Every time the user taps on the touch sensitive surface 104, he causes to be produced the sound note next in sequence within the phrase. The duration of interval between any two of the user's taps determines the interval between the two corresponding sound notes. The intervals need not be regular. As music composers know, varying the intervals between sound notes produces very different music even if the same order of sound notes is used.

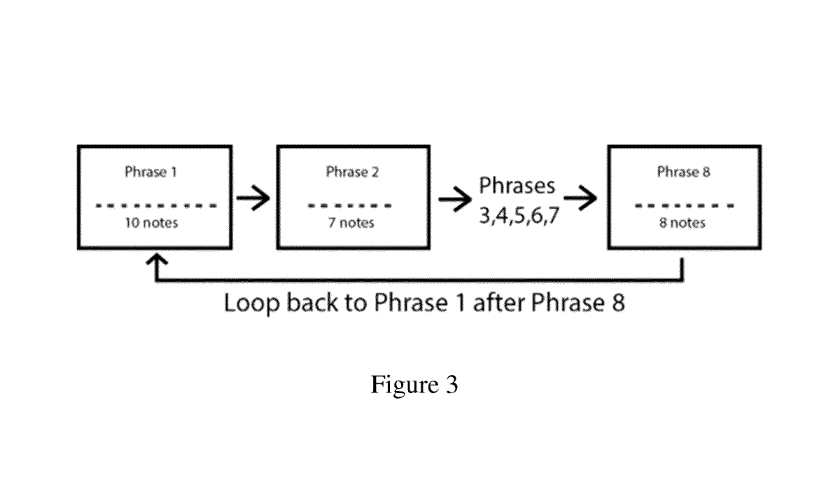

Preferably, the memory has a collection of different phrases which the user can select to play. If the user does not select any of the phrases to play in particular, the phrases are played in succession as the user taps away on the touch sensitive surface 104 continually. When all the phrases in the memory have been played, the sound synthesizer 101 loops back to the first phrase. FIG. 3 shows how eight different phrases are played and then looped back to the first phrase.

The phrases are preferably short. For example, a phrase may comprise any number of sound notes from 4 to 100 of any tone in the present musical scale. This facilitates the user to select and order different short phrases to be played one after the other easily, to append the phrases in any order into a combined, longer piece of music. By combining different phrases with an infinite possibility of rhythmic variations, there is no limit to the music that the user could make on the sound synthesizer 101.

Preferably, the sound notes in the phrases were pre-determined based on the pentatonic scale. The pentatonic scale is used all around the world in different types of music. Compared to the major and minor scales, the relatively limited number of sound notes in the pentatonic scale means the absence of the most dissonant intervals. Any succession of the sound notes in the pentatonic scale may be played in any order or combination without resulting in excessive dissonance. Limiting playable sound notes to only the pentatonic scale allows ethnic, jazz, rock and blues melodies to be emulated with ease, without fear of executing “wrong sound notes”. This is because a large number of popular rock, jazz, and blues solos are based mostly, or entirely, on the pentatonic scale.

Nevertheless, the pentatonic scale is also highly compatible to music written in both major and minor keys, which are the two mostly used scales in western music. Therefore, a pentatonic phrase may be played alongside western music written in either the major and minor scale, and their combination is likely to be musical instead of dissonant.

Therefore, although the order of the sound notes has been pre-determined, the produced by the user music using the sound synthesizer 101 is entirely original since it is dependent on the user's sense of timing between taps on the touch sensitive surface.

The intensity of the user's touch on the touch sensitive surface 104 gives different readings in the capacitance sensor. The different readings are translated into different velocity of the sound note produced. Sound note velocity is a measurement of loudness used in the MIDI format, which is short for Musical Instrument Digital Interface. Tapping on the touch sensitive surface 104 softly produces a sound note of lower volume. Tapping on the touch sensitive surface 104 firmly produces a sound note of higher volume. In this way, the user produces sound notes of different velocities depending on the force of tapping on the touch sensitive surface 104.

In practice, the sound synthesizer 101 can be played by tapping a single finger on the touch sensitive surface, or by drumming any number of fingers on the touch sensitive surface. It is possible to tap on the touch sensitive surface alternating between using the index and middle finger similar to finger picking on a bass guitar.

Other than educational purposes, the sound synthesizer 101 could find use as a lead instrument to be played solo with the support of a backing music. Such backing music is easily available for rock music jams by downloading from the Internet or in compact disc form from musician stores. The user does not need to know the next sound note in the phrase because the pre-determination of sound notes based on a compatible scale means the sound note will be resonant. In contrast, leading a jam session using other melodic instruments require much training in musical knowledge and music reading to select the right keys and achieve satisfactory musicals results.

An example of a suitable processor 202 useable in the sound synthesizer 101 is a controller powered by a Seeeduino Film, which is a processor in the form of a flexible, super slim film, with built-in Li-Po charger, and which is flexible enough to be fitted into the housing.

By way of example, The memory 200 in the sound synthesizer 101 comprises a Max/MSP patch, which a program for responding to signals from the capacitance change of the touch sensitive surface by selecting and outputting a sound note. ‘Max/MSP’ is a visual programming language for music and multimedia which is widely used for creating innovative recordings. Max programs are called “patches”. The MAX patch in this embodiment contains a library which includes, for example, an electric guitar sample library so that the user can play improvised guitar solo music by tapping on the touch sensitive surface.

A preferred electric guitar sample library is the Prominy LPC Electric Clean 5 6 Guitar which runs on Native Instruments Kontakt 5. This library has an “auto-sustain” feature by where the user finger may leave the control plate but this will not stop sustained sounding of the sound note being played until the next sound note is played. With this feature, tapping on the sound synthesizer 101 controller plays sustained sound notes rather than staccato sound notes. Accordingly, the sound synthesizer 101 is capable of playing unique sounding blues or rock sounding guitar solos with endless possibilities in rhythm and phrasings. Again, if only sound notes from the pentatonic scale are used, this would successfully remove potential dissonance between sound notes, as could happen if the chromatic scale is used.

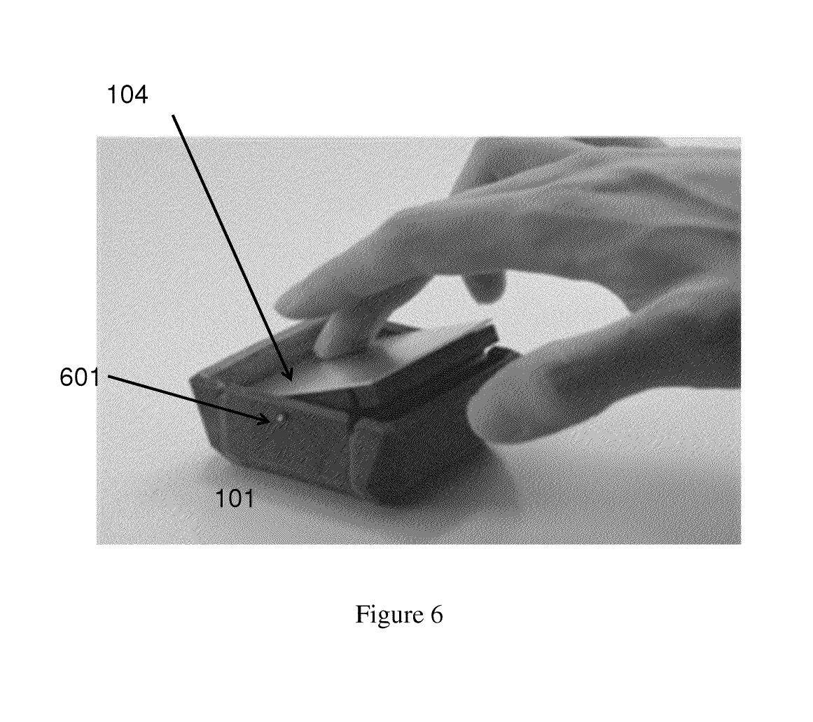

FIG. 6 shows a variation of the embodiment. A central shaft axle 601 is connected to the metal plate to secure the touch sensitive surface 104 onto two opposite sides of the housing 102 of the sound synthesizer 101, such that the touch sensitive surface 104 is capable of being swivelled about the axle 601 when the user pushes on the touch sensitive surface 104 on one side of the axle. A rubber band or any other form of mechanical memory device is fixed on each side of the axle so that the touch sensitive surface 104 returns to the original position resiliently. The mechanical memory gives the user a feel of tension feedback when he pushes on the touch sensitive surface 104. Preferably, the tension caused by the rubber bands mimics the tension of bending strings on a guitar. The extent of the tilt of the touch sensitive surface 104 is detectable by a flex sensor attached to the bottom of the metal plate. The music synthesizer 101 is programmed such that tilting the metal place adds aftertouch effects to the sound note being played. The flex sensor can be a simple metal strip of a gyrometer, which are well known technology that has no need of elaboration here.

Aftertouch is the effect when one has struck a key and while still depressing the key to apply more pressure and control a variety of effects or parameters, similar to adding vibrato to a string instrument. Having aftertouch effect adds to the variety of responses the sound synthesizer 101 may produce response to touch.

In other words, the responsiveness of the metal plate to the impact of the touch, extent and duration of tilt allows the user to express variables such as dynamics and pitch modulation with movements of a single finger. The sound synthesizer 101 allows creative control over the music played in terms of pitch bends, vibrato, volume modulation, tempo, rhythm, thrills, moods, loudness or other expressive variables, which creates very different sounding musical phrases even though the same order of sound notes is used. The burden of reading music score and selecting the correct sound note to play is removed from the user. Even if the user plays the same timing variations or rhythmic patterns with different phrases, different sounding music will be produced. Therefore, the sound synthesizer 101 provides the possibility of a high level of musical expressiveness to the user, which encourages the user to develop a sense of rhythm and to discover more rhythmic patterns to enrich musical variations of possible output.

An example of commercial use of the sound synthesizer 101 is as part of the turntable of a disc jockey. The sound synthesizer 101 allows the disc jockey to merge impromptu, self-generated, original musical embellishments to complement the music he is playing from compact discs or vinyl discs.

Although the sound synthesizer 101 has been described as producing sound according to the pentatonic scale, sound notes according to other scales may nevertheless be played in other embodiments, as long as musical dissonance is kept to a minimum. This really depends on the sound note pre-selection and the backing music selected to complement the sound notes. Expanding the possible musical scales allows sound synthesizer 101 to be used to produce even more different sounding phrases and to extend the music palette of the sound synthesizer 101, while remaining simple and easy to use.

In a variation of the embodiment, a further or second capacitive touch surface for the thumb is provided at the side of the housing 102 as a stop or mute key for use with auto-sustain effects. When this second capacitive touch surface is touched, the sound synthesizer 101 is muted and does not produce any more auto-sustained sound even when the first capacitive surface or touch sensitive surface 104 is touched. When the second capacitive touch surface is touched again, auto-sustained sound output is resumed when the user touches the first capacitive surface.

In another embodiment, the controller messages are sent wirelessly through Bluetooth communication into a computer that in turn plays the phrases, instead of producing the sound notes via a speaker in the sound synthesizer 101 itself.

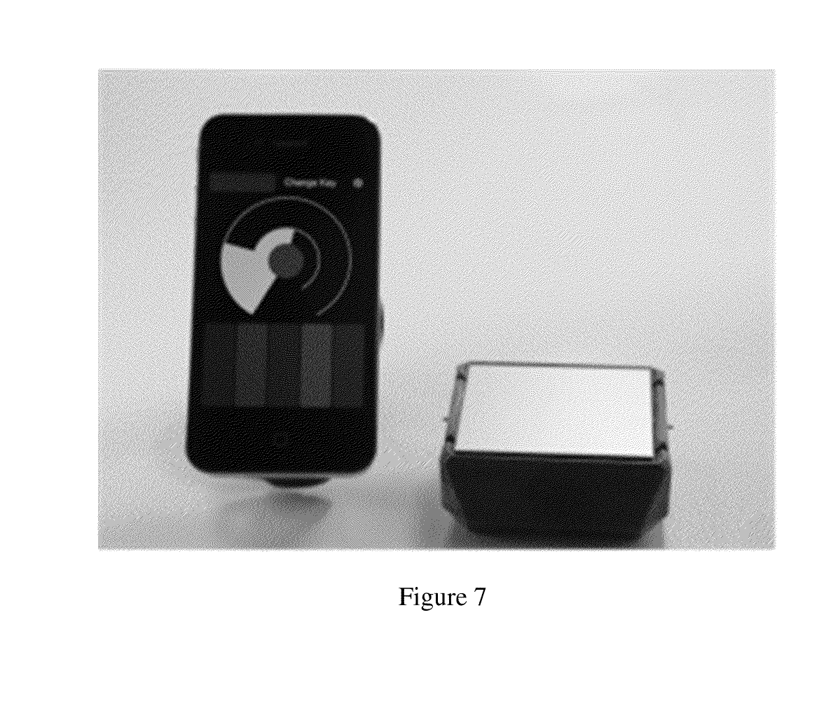

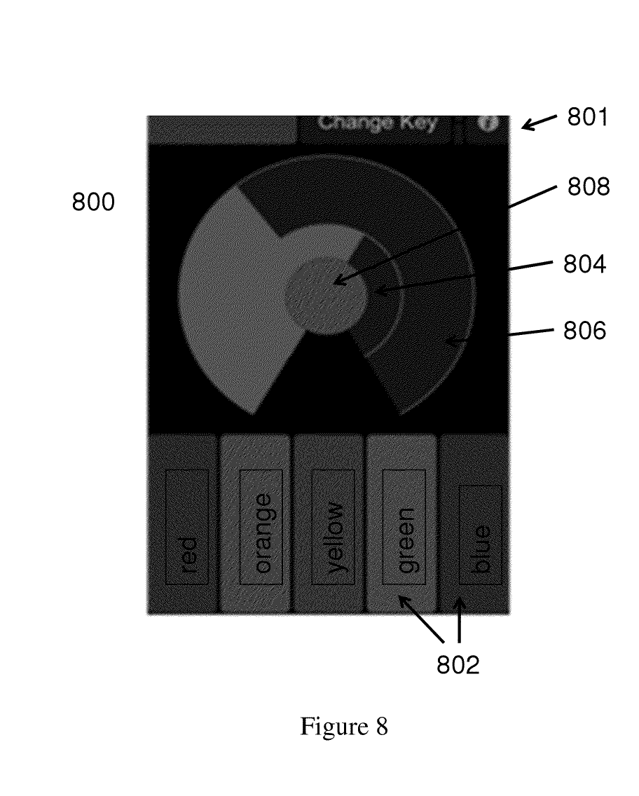

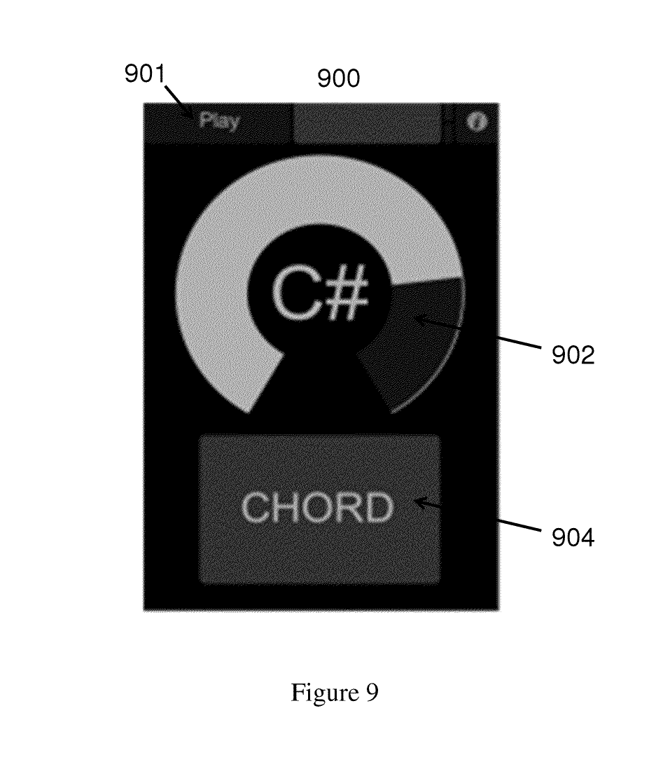

Preferably, a graphical user interface is provided to allow user control for style and key switching, and to give visual indications to assist the playing of sound synthesizer 101. The interface can be integrated into the housing, in which case, the housing will need to be bigger to accommodate the graphical user interface. Optionally, as illustrated in FIG. 7, the graphical user interface can be a smart phone application which communicates with the sound synthesizer wirelessly. The application comprises two switchable graphical user interfaces: a Play screen 800 as shown in FIG. 8, and a Change Key 900 screen as shown in FIG. 9. Both these screens 800, 900 can be used to switch music style or change the music key.

The Play screen 800 switches over to the Change Key 900 when the Change Key button 801 at the top of the Play Screen 800 is pressed. Conversely, when the user can press on the Play tab 901 on the top of the Change Key 900 screen to return to the Play screen 800.

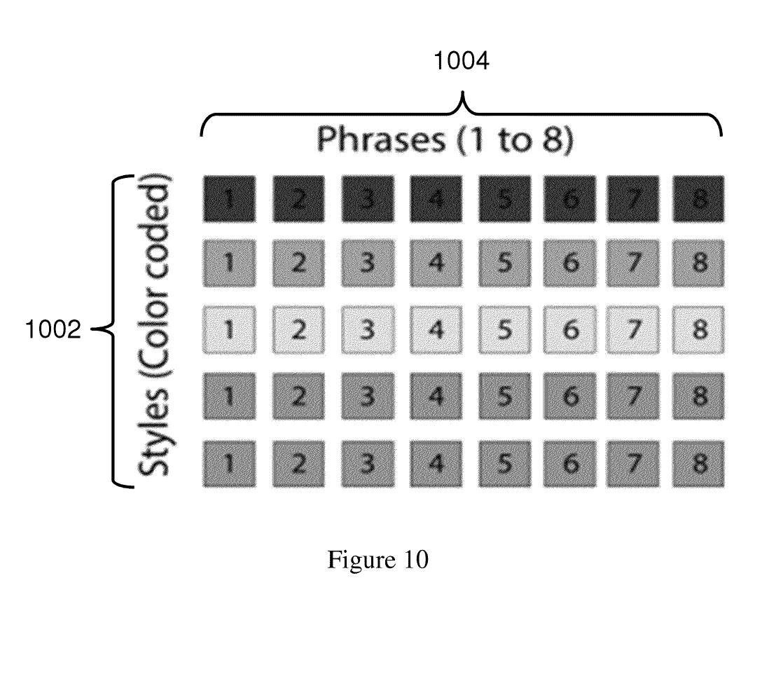

Although reproduced in grey tones in this specification, the Play Screen 800 illustrates a diagram with phrases represented in five “styles” that are color-coded red, orange, yellow, green and blue. Accompanying FIG. 10 shows how each style 1002 is made up of eight phrases 1004. When the user plays music from the sound synthesizer 101, phrases of only the same style are played in succession by default. The user may use the Play Screen 800 to switch into another style, by pressing on a style button 802 at the bottom of the Play Screen 800. Each of the style buttons is coloured to distinguish the styles from each other. The switching over of the style preferably only happens at the completion of the currently playing phase.

The Play Screen 800 shows two coloured wheels 804, 806 which are for indicating the position of the current sound note in the phrase being played. The outer wheel is called the Phrase Wheel 806. The Phrase Wheel 806 is divided into eight slots corresponding to the eight phrases 1004 as illustrated in FIG. 10; each slot represent a phrase out of the eight phrases. Each time a phrase is completed and the music being played progresses to the next phrase, the coloured fill of the Phrase Wheel moves up by one slot clockwise. When all eight phrases of the same style 1002 have been played, all the eight slots are filled up to display a fully filled Phrase Wheel 806.

The inner wheel is known as the Sound Wheel 804. The Sound Wheel 804 counts down the number of remaining sound notes in the currently playing phrase. For greater visual impact, the Sound Wheel 804 starts off fully filled with the phrase colour. When there are less than eight sound notes left to be played in the phrase, the slots are uncoloured one by one in the anticlockwise order for every one of the remaining eight sound notes played. When the last sound note is played, the Sound Wheel 804 has no more colour filled slots. When the sound synthesizer 101 progresses to play the next phrase, the Sound Wheel is fully filled with colour again.

When a style button 802 on the Play screen of FIG. 8 is pressed, the centre 808 of the inner wheel 804 changes to the colour of the selected style, indicating that the next phrase will be of that selected style.

The user is free to tap on any phrase button at any time without any immediate effect, the style change will only takes place at the start of the next phrase. When the last sound note of the current phrase is played, the colour of the indicator wheels 804, 806 will be changed to the colour of the selected style, illustrating to the user that the sound synthesizer 101 will be playing the set of sound notes from that style indicated by that colour.

The Key Change screen 900 is used to change the key in which the phrases are played. A white wheel known as the Key Wheel 902 enables fast switching of keys by the user just sliding his finger across the Key Wheel 902. Users can change from the key of E to the next key Eb almost one octave away. The user can press on the Chord Button 904 under the Key Wheel 902 to listen to a chord sample in that key. This is useful to the user for matching the key of sound synthesizer 101 to the key of any backing music.

A sound synthesizer 101 has been described comprising a surface 104; an audio output capable of providing a different sound note each time the surface 104 is touched.

Accordingly, the sound synthesizer 101 is a hardware-software integrated system that allows improvised performance of jazz, blues or rock sounding guitar solos to be more accessible to novice musicians. By combining a capacitive touch controller and pre-determined library of sound notes of a predetermined scale, the user can play sound notes in any rhythmic patterns without the risk of landing on dissonant sounding sound notes.

Exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the embodiments as described shows that the accompanying software application 800,900 communicates wirelessly with the sound synthesizer 101 via Bluetooth or other wireless communication mode, and the application may be stored in a smart phone such as the iPhone™. However, the application may be displayed in an integral screen to the housing 102 instead of being in a separate device.

In variations of the embodiment, the sound synthesizer can be used in combination with a MIDI keyboard to control string vibrato normally played with pitch wheels.

Optionally, a resistive touch sensor may be used but such sensors are less sensitive than capacitive touch sensors and also require a certain amount of push force for a touch to be sensed.

What is claimed is:

1. A sound synthesizer comprising
a surface;
an audio output capable of providing a different sound note each time the surface is touched.

2. A sound synthesizer as claimed in claim 1 wherein
the sound note is randomly selected from a pre-determined musical scale.

3. A sound synthesizer as claimed in claim 2 wherein the pre-determined musical scale is pentatonic.

4. A sound synthesizer as claimed in claim 1 wherein
the surface is capable of sensing the intensity of the touch; and
the velocity of the sound note produced is proportional to the intensity of the touch.

5. A sound synthesizer as claimed in claim 1 wherein
one consecutive sound note in a pre-determined sequence of sound notes is played each time the surface is touched consecutively.

6. A sound synthesizer as claimed in claim 5 further comprising
a display;
the display indicating that the position of the consecutive sound note in the pre-determined sequence of sound notes.

7. A sound synthesizer as claimed in claim 1 wherein the sound note is produced with aftertouch effects.

8. A sound synthesizer as claimed in claim 7 wherein
the surface is resiliently movable; and
the extent of the surface resiliently moved determining the extent of the aftertouch effects of the sound note being played.
